(19) United States
(12) Patent Application Publication
(10) Pub. No.: US 2019/0014882 A1
(43) Pub. Date: Jan. 17, 2019

(54) AROMA TESTER

(71) Applicant: Julian F. BEDEL, New York, NY (US)

(72) Inventor: Julian F. BEDEL, New York, NY (US)

(21) Appl. No.: 15/649,132

(22) Filed: Jul. 13, 2017

(51) Int. Cl. A45D 34/02; B05B 1/02; B65D 51/24

(52) U.S. Cl. CPC A45D 34/02; A45D 2034/002; B65D 51/24; B05B 1/02

(57) ABSTRACT

A sniffing system and method for perfume testing is described, where perfume aromas and the perfumes themselves are precluded from mixing and remain independent of one another. In particular, the present invention includes a specialized covering for maintaining an aromatic smell for testing purposes yet precluding mixing of perfumes when being tested.

The present invention is directed to an improved system and approach to a diffuser/sniffer for aromas, such as but not limited to perfumes.

### BACKGROUND OF THE PRESENT INVENTION

In general, perfumes are formulated from a combination of essences embedded in a carrier, such as a commonly used alcohol carrier and the perfume is kept in closed bottles. Alcohol is commonly used due to its ability to act as a uniform suspension medium and its ability to rapidly diffuse. Some perfumes have additional ingredients, such as a coloring agent or an ultraviolet protector. When a perfume is used, such as on a person's skin, the alcohol content comparatively rapidly dissipates or evaporates, leaving the essence combination and its continued aromatic qualities behind. The carrier, however, is important to the perfume in that it allows for a uniformly distributed medium for spraying or applying, thereby distributing the essences across a wide area, such as of a person's body when sprayed on the body, thereby providing more surface area for emanation of the aromas of the combination of uniformly distributed essences.

When stored in glass bottles, the essences of the perfume tend to be relatively uniformly distributed in the medium in the bottles.

Perfumes are often stores in retail environments in sample bottles, typically glass, and in the presence of other bottled perfumes. The sample bottles often are just like the actual for-sale bottles, but with a dedicated sprayer attached. The dedication of the sprayer is important in that the retailer needs to assure that different perfumes and their aromas do not mix. Each perfume is bottled separately and each has its own distinct aroma. At least for testing purposes, each sample bottle has its own attached sprayer. When a potential purchaser needs to decide which of the several available perfumes to purchase, the potential purchaser tests each individually, ordinarily by spraying each into a piece of heavy weight paper, called a “blotter” or “touche”, into the air or onto their hand or arm or, more likely, a combination. When sprayed into the environment, the alcohol (or other medium) dissipates, but the essence and therefore the aromatic smell stays behind and can linger for some time. There are several problems with this approach. The major problems include:
If perfume is sprayed in the air, there is no way for the customer taking the sample away.
If perfume is sprayed on skin, the consumer is risking not liking the scent and will have to live with it for some hours. Further, the consumer will soon run out of skin for testing.
When sprayed in an open environment, it becomes challenging for a consumer to compare formulations such as to identify common preferable attributes of perfumes, especially when dozens may be available for testing. It would be beneficial to be able to have a means for narrowing the selection process.
The retail environment cannot stand many perfumes being sprayed in the same area. After a couple of customers, the area can become loaded with a heavy combination of perfume. Also, depending upon the frequency of air exchange customers can arrive to a contaminated environment which possibly affects their choice.
In addition, perfumes often include a flowery smell and/or the essence from aromatic plants. It can be the case that some people entering a room where certain essences have been sprayed previously could have an adverse reaction, such as an allergic reaction.
Bottle handling. Usually the act of taking a bottle and a blotter and then spraying is tedious, particularly if testing 20 to 50 perfumes. Our invention is more practical in the speed and discovery process, taking advantage of the limited time of the customer.
For the business this invention represents a big saving in perfume dedicated for sampling. For the present invention, the loss of perfume due to testing can be limited to one or two sprays per day.
The aroma of each perfume needs to be totally separated from other aromas. Therefore, each aroma, when sprayed, needs sufficient time and/or air flow in the room to fully dissipate in order for the potential purchaser to adequately identify individual aromas. This is particularly problematic with perfume because, by its nature perfume tends to have the aroma be long-lasting.
In addition, because it takes time for the medium to dissipate or evaporate and the medium may have its own aroma, if smelled very soon after spraying, the actual smell of the essences may be diluted by the medium. Ordinarily, when testing, the potential purchaser sprays and quickly smells the perfume. Such a test is not indicative of the long term effect of the essences.

Consequently, it would be beneficial to have a system and method to overcome these issues.

### BRIEF DESCRIPTION OF THE INVENTION

The present invention is directed to overcoming these problems by introducing a sniffing system and method where aromas and perfumes do not mix and remain independent of one another. In particular, the present invention includes a specialized covering (“flask”) for maintaining an aromatic smell for testing purposes yet precluding mixing of perfumes when being tested.

When someone such as a potential purchaser wishes to smell a particular fragrance, instead of spraying the fragrance into the air, onto their arm or hand, or elsewhere, where the aroma could become airborne or mix with other aromas, they can merely lift the covering and smell inside the covering. Assuming there is a plurality of options to smell, each fragrance remains housed in its own covering and there is no potential mixing between fragrances. The aroma of each is unadulterated or altered in any way. The present invention overcomes the problem of the retail experience of trying a scent.

The present invention completely changes how scents are sampled in an ambience such as the sales floor of a department store, where so many companies are continuously spraying perfume into the air.

### DESCRIPTION OF THE FIGURES

FIG. 1 depicts a bottle of the present invention including a sprayer and bottle lip.

FIG. 2 depicts a covering such as usable in the present invention.

FIG. 3 depicts a bottle and covering side-by-side.

FIG. 4 depicts a top perspective view of a bottle usable in the present invention.

FIG. 5 depicts a collection of bottles with individual coverings.

### DESCRIPTION OF THE PRESENT INVENTION

The present invention is directed to a sniffing system where aromas and perfumes do not mix and remain independent of one another. The system of the present invention includes a specialized bottle with perfume in the bottle, a sprayer sealably attached to a bottle, such as via screw-on, a stand or another flat surface on which the bottle and/or covering rests, and a specialized covering for the bottle/sprayer combination.

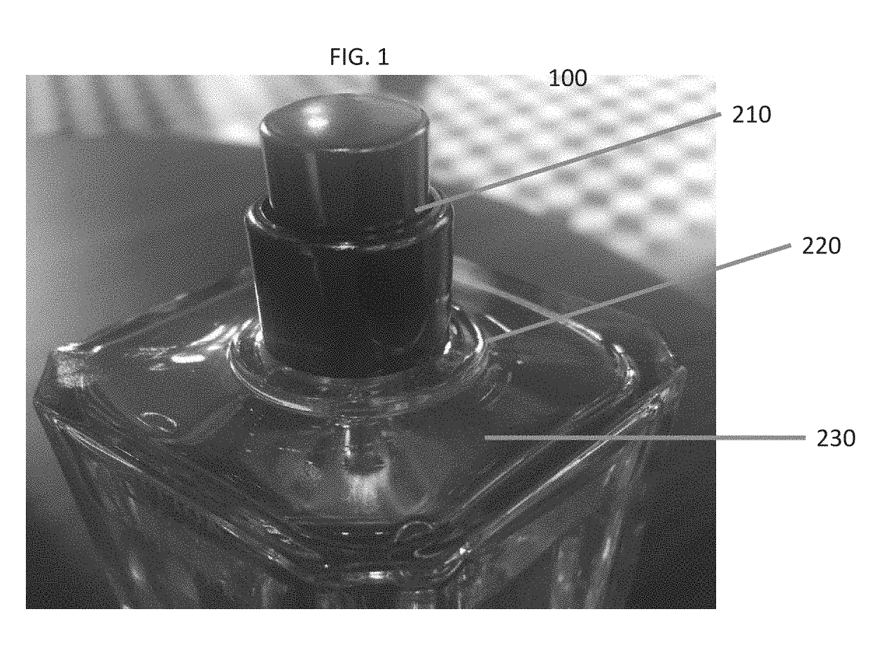

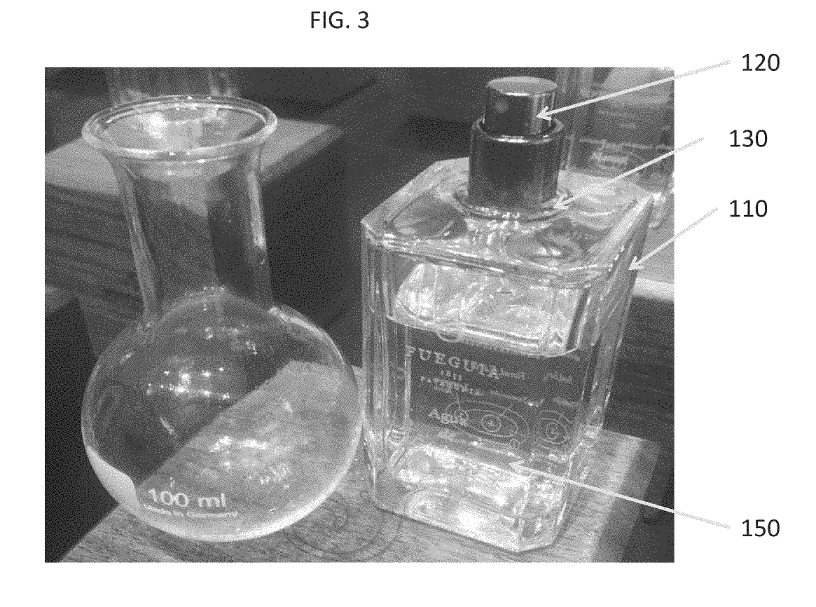

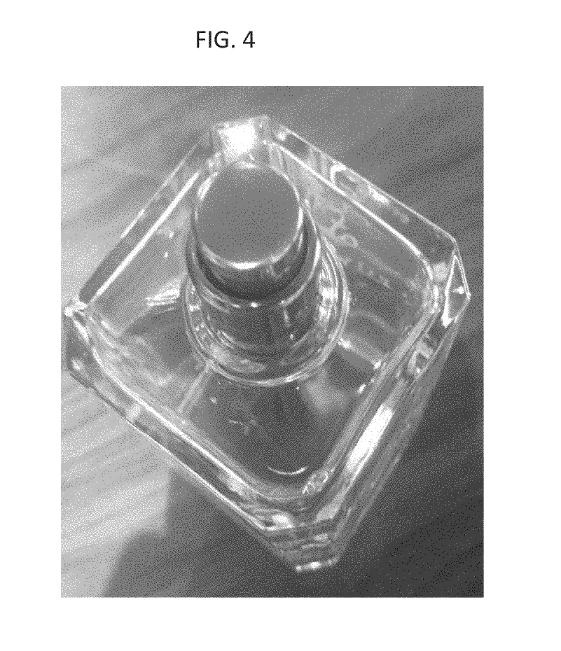

The bottle 100 of the present invention is shown in FIGS. 1 and 3 and encompasses a storage container 110 for perfume 150 sealed with a spraying unit 120 at the bottle's top. FIG. 4 shows a view from above and to the side. Surrounding the spraying unit on the top of the bottle is an elevated lip 130. In at least one embodiment, the shape of the body of the bottle is octagonal.

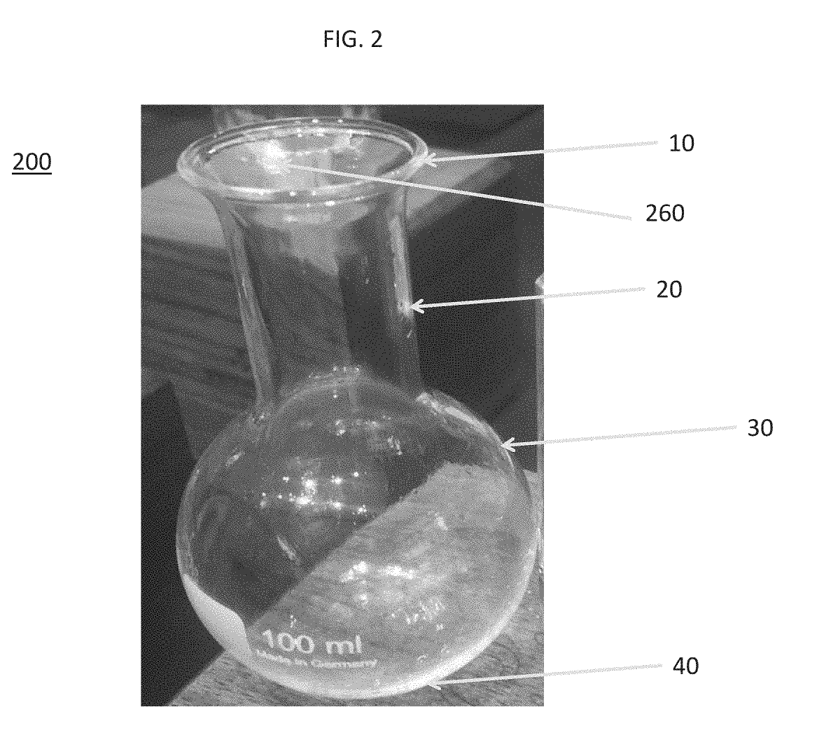

Covering 200 of the present invention is a key to the system's utility. The shape of the covering is preferably generally similar to that of a common flask and is that of a cylindrical portion 20 (a “neck”), open at both ends including one open end combined into an opening of sphere 30. The combined covering unit can be formed of a number of shapes but preferably has a single exterior opening 260 located at a base of a cylinder. See FIG. 2. Covering 200 has a flat bottomed surface 40 within sphere 30, opposing exterior opening 260. Covering 200 includes several attributes which together provide an overall improvement, however different combinations of attributes can be available for improvement as well. Covering 200 is preferably made of glass, and more specifically of a form of glass, such as Borosilicatte laboratory glass, which includes protection from oxidation (or other contamination) of the scent and/or does not modify the scent. Alternatively another non-porous or porous material may be used for the covering. Preferably the material should be inert. For example, a porous material, such as but not limited to porcelain can be used, as such a porous material includes the capacity to retain the perfume's essence in the material without altering the smell. The choice of the material could be a commercial choice of the perfumer in order to evaluate which flask material is better for a specific type of perfume family. The interior of the flask could also be treated in some way, such as but not limited to being sand blasted, so as to form porosity and “trap” the essence. Also it is possible that the covering would include a treated neck, such as by sand blasting, in order to make it less slippery and avoid dripping of the sprayed perfume.

In the preferred embodiment, covering 200 is flat bottomed 40. In the preferred embodiment, at opening 260, covering 200 includes a covering lip 10. When placed, such as with opening 260 covering the sprayer, the opening creates an opportunity for a virtual seal with the perfume bottle or another flat surface. This virtual seal also provides relative stability in that the lips are arranged to limit opportunity for the covering to be unintentionally unseated.

The cylindrical portion 30 provides a funnel-effect for a spray. The perfume or other aromatic spray is sprayed into the covering and the sprayed perfume remains housed in and uniformly distributed in the interior of the sphere.

In at least one embodiment, material can be included in the interior of the covering at or near the flat bottom or, alternatively or in addition, along an interior side of the sphere. The material is preferably an absorbent material, such as one that would retain the sprayed perfume's essence. In one embodiment, the material is cotton. The material may simply be left “floating” inside the covering or possibly be attached to the interior by using a glue. In at least one embodiment, the spherical element is replaced by an element with a different shape and in which the material would be trapped. In another embodiment the material could line the neck.

FIG. 3 depicts a bottle and covering along side one another, showing the covering resting on a table with the opening up.

In the method of the present invention, the covering remains over the perfume bottle and in contact with a table, base, or sprayer bottle. When covering 200 remains on bottle 100, elevated lip 130 and covering lip 10 each protrude from their respective elements and are in sufficient proximity with one surrounding the other that covering 200 remains stable on bottle 100, such as if accidentally bumped into.

When a possible purchaser wishes to test a perfume, they do so by smelling into the covering, not by spraying.

Someone, such as a perfumist or an employee would spray perfume into the covering. The perfumist/employee would lift the covering, spray one or a small number of squirts into the covering, place covering flat bottomed 40 on a surface, wait a short time (such as a minute or up to five minutes) and then place the covering back onto the bottle with the flat surface down. Once sprayed, the sprayed perfume becomes distributed in the sphere, typically uniformly, but by leaving the covering open for a short time, the carrier can dissipate, leaving the essences without means to easily or readily escape, by nature of the sole opening being on the bottom. At least a portion of the essences adheres to the inner surface of sphere 30. By spraying directly into the bottle, the sprayed perfume is not released to the room or onto a person. The aroma in the sphere typically lasts an entire day or longer. Consequently, the sprayed perfume largely or exclusively remains indefinitely in the covering without means for mixing with other perfumes.

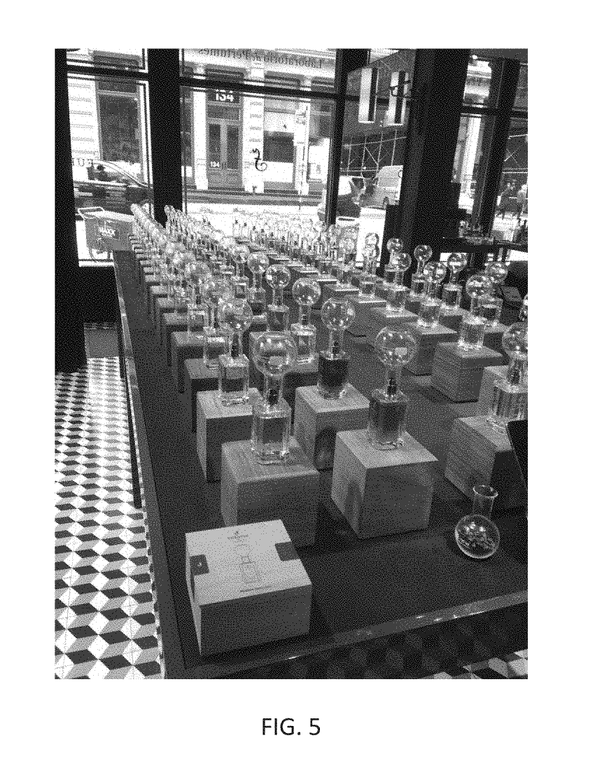

When a customer comes along, they can lift and smell into the covering in order to test the perfume. As can be seen in FIG. 5, numerous perfumes can each separately be housed, each with its own covering.

In addition, because the carrier is dissipated from the covering, the aromas remaining behind are a more pure representation of the aromas as they are not combined with any smell from the carrier or from other perfumes.

When someone such as a potential purchaser wishes to smell a particular fragrance, instead of spraying the fragrance into the air or onto their arm or hand, they can merely lift the covering and smell inside the covering. Assuming there is a plurality of options to smell, each fragrance is housed in its own covering and there is no mixing between fragrances.

1. A system for testing a perfume comprising:
a container for storing perfume with a single opening;
a sprayer attached to and forming a seal with said container at said container's single opening; and
a single-opening, flat-bottomed covering;
where said container includes a first raised lip surrounding its single opening, and said covering has a second raised lip, and said first raised lip and said second raised lip form concentric circles when said covering is placed over said sprayer such that said sprayer is inside said covering.

2. The system of claim 1, wherein said covering is made from glass.

3. The system of claim 1, wherein said covering is made from ceramic.

4. The system of claim 1, wherein the interior of said covering is porous.

5. The system of claim 1, wherein an absorbent element is housed in said covering.

6. The system of claim 1, wherein said covering includes a neck with a first end and a second end, said first end opens to the outside and said second end opens to a largely spherical member.

7. The system of claim 6, wherein said neck is cylindrically shaped.

8. A method for testing perfume comprising the steps of:
with a sprayer attached to a bottle housing perfume, spraying said perfume into a single opening of a covering;
allowing said covering to be open to the environment for a nominal time period;
inverting said covering such that it covers said sprayer; and
on demand, removing said covering from said bottle for testing the smell of the perfume sprayed in the bottle;
wherein said bottle includes a first raised lip surrounding its single opening, and said covering has a second raised lip, and said first raised lip and said second raised lip form concentric circles when said covering is placed over said sprayer such that said sprayer is inside said covering.

9. The method of claim 8, wherein said covering is made from glass.

10. The method of claim 8, wherein said covering is made from ceramic.

11. The method of claim 8, wherein the interior of said covering is porous.

12. The method of claim 8, wherein an absorbent element is housed in said covering.

13. The method of claim 8, wherein said covering includes a neck with a first end and a second end, said first end opens to the outside and said second end opens to a largely spherical member.

14. The method of claim 13, wherein said neck is cylindrically shaped.

15. A method for separating perfume smells comprising the steps of:
with a sprayer attached to a bottle housing perfume, spraying said perfume into a single opening of a covering;
allowing said covering to be open to the environment for a nominal time period;
inverting said covering such that it covers said sprayer; and
on demand, removing said covering from said bottle for testing the smell of the perfume sprayed in the bottle;
wherein said bottle includes a first raised lip surrounding its single opening, and said covering has a second raised lip, and said first raised lip and said second raised lip form concentric circles when said covering is placed over said sprayer such that said sprayer is inside said covering.

16. The method of claim 15, wherein said covering is made from glass.

17. The method of claim 15, wherein said covering is made from ceramic.

18. The method of claim 15, wherein the interior of said covering is porous.

19. The method of claim 15, wherein an absorbent element is housed in said covering.

20. The method of claim 15, wherein said covering includes a neck with a first end and a second end, said first end opens to the outside and said second end opens to a largely spherical member.
